(19) United States
(12) Patent Application Publication
(10) Pub. No.: US 2019/0271190 A1
(43) Pub. Date: Sep. 5, 2019

(54) BLIND DECORATIVE BOARD FIXING SUPPORT ASSEMBLY

(71) Applicant: Tser Wen CHOU, Yorba Linda, CA (US)

(72) Inventor: Tser Wen CHOU, Yorba Linda, CA (US)

(21) Appl. No.: 15/911,659

(22) Filed: Mar. 5, 2018

(51) Int. Cl. E06B 9/323; E06B 9/266

(52) U.S. Cl. CPC E06B 9/323; E06B 9/266

(57) ABSTRACT

A blind decorative board fixing support assembly includes a decorative board main body, a left-side cover board, a right-side cover board, a connection seat and a hanging bracket hanging on and latching with a blind frame rail. Protruding insertion blocks are disposed on the inner face of the decorative board main body. The inner end faces of the left-side cover board and the right-side cover board are formed with insertion frames for inserting and connecting with the insertion blocks. The connection seat is securely disposed on the insertion blocks and the hanging bracket is securely hanged on and connected with the connection seat, whereby the decorative board main body, the left-side cover board and the right-side cover board can be hanged on and latched with the blind frame rail to seal and cover the blind accessories so as to achieve a beautiful appearance and fast installation effect.

### BACKGROUND OF THE INVENTION

### 1. Field of the Invention

The present invention relates generally to a blind decorative board fixing support assembly, and more particularly to a blind decorative board structure, which can be fast installed and can enhance the beauty of the blind.

### 2. Description of the Related Art

Currently, the structure for installing a blind generally includes two supports disposed on two sides of a window for securely supporting the entire blind accessories. In order to achieve a beautiful appearance, a set of decorative board is often disposed on outer side of the blind accessories to conceal the blind accessories so as to enhance the beauty of the blind. However, the decorative board of the conventional blind is made by decoration and it is quite complicated to install and assemble the decorative board and the cost for the decorative board is considerably large. Especially, it is laborious and time-consuming to install the decorative board and once the decorative board is nailed and fixed, it will be hard to change the decorative board. In the case that it is desired to change the decorative board, it is necessary to take down the decorative board and redecorate. This leads to great waste and inconvenience, which are not what we expect.

### SUMMARY OF THE INVENTION

It is therefore a primary object of the present invention to provide a blind decorative board fixing support assembly, which can be fast installed and can enhance the beauty of the blind. The insertion blocks of a decorative board main body are inserted and connected with the insertion frames of a left-side cover board and a right-side cover board so as to assemble the decorative board main body and the left-side cover board and the right-side cover board into a decorative board substrate body for covering the blind accessories. Via a connection seat, the decorative board substrate body is connected with a hanging bracket, which is hanged on and latched with the blind frame rail of the blind accessories to seal and cover the blind accessories so as to achieve a beautiful appearance and fast installation effect.

To achieve the above and other objects, the blind decorative board fixing support assembly of the present invention mainly includes a decorative board main body, a left-side cover board, a right-side cover board, a connection seat and a hanging bracket. The front end face of the decorative board main body is formed with a plain panel or striped end face. The upper and lower end faces of the rear side of the decorative board main body are respectively formed with an insertion block. The inner end faces of the left-side cover board and the right-side cover board are formed with breakage slits. In addition, insertion frames are disposed on the inner end faces of the left-side cover board and the right-side cover board for correspondingly inserting with the insertion blocks of the decorative board main body. The insertion frames have more than one insertion spaces for receiving and connecting with the insertion blocks. The connection seat is securely disposed on the insertion blocks of the decorative board main body. The connection seat includes a vertical plate, an adjustment notch formed on the vertical plate and a horizontal engagement channel protruding from the upper side of the vertical plate. Engagement teeth are formed on the inner face of the horizontal engagement groove for integrally engaging with the hanging bracket. The hanging bracket includes a toothed plate for engaging with the horizontal engagement groove of the connection seat and a clip body for hanging on and latching with the blind frame rail. A stop block protrudes from the inner face of the clip body for abutting against the inner side of the blind frame rail.

The present invention can be best understood through the following description and accompanying drawings, wherein:

### BRIEF DESCRIPTION OF THE DRAWINGS

FIG. 1 is a perspective exploded view of the present invention;

FIG. 2 is a perspective assembled view of the present invention;

FIG. 3 is a perspective view of the connection seat of the present invention;

FIG. 4 is a perspective view showing the installation of the connection seat of the present invention;

FIG. 5 is a perspective view of the hanging bracket of the present invention;

FIG. 6 is a perspective view showing the assembly of the hanging bracket of the present invention;

FIG. 7 is a perspective view showing the use of the hanging bracket of the present invention;

FIG. 8 is a perspective view of another embodiment of the hanging bracket of the present invention;

FIG. 9 is a perspective assembled view of another embodiment of the hanging bracket of the present invention;

FIG. 10 is a perspective view showing the use of the other embodiment of the hanging bracket of the present invention;

FIG. 11 is a perspective exploded view of another embodiment of the present invention; and

FIG. 12 is a perspective assembled view of another embodiment of the present invention.

### DETAILED DESCRIPTION OF THE PREFERRED EMBODIMENTS

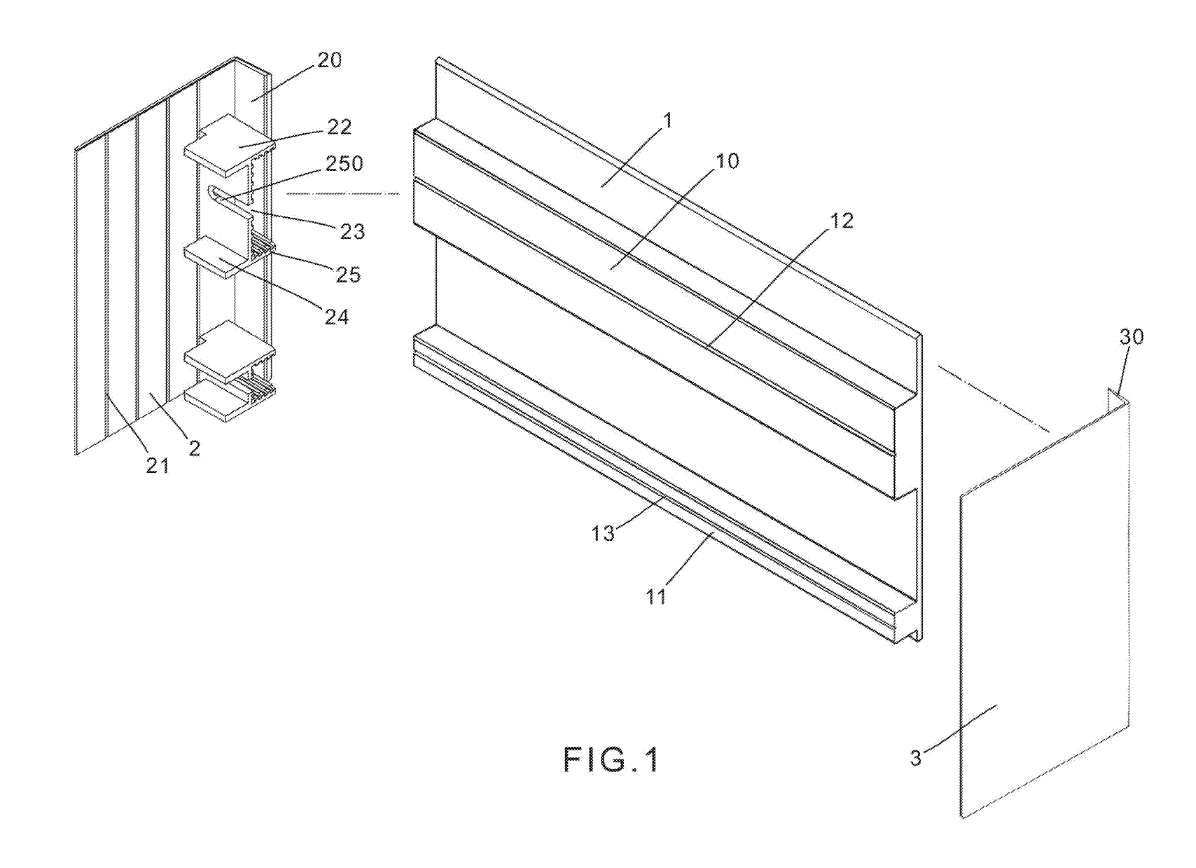

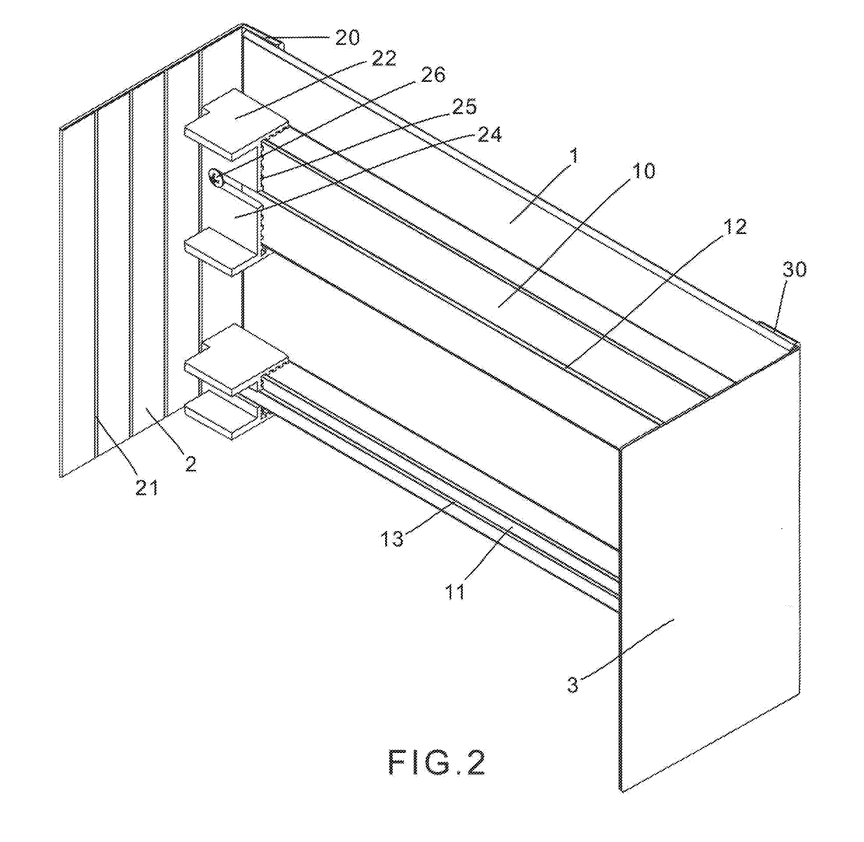

The blind decorative board fixing support assembly of the present invention mainly includes a decorative board main body 1, a left-side cover board 2, a right-side cover board 3, a connection seat 4 and a hanging bracket 5. Referring to FIG. 1, the front end face of the decorative board main body 1 is formed with a plain panel or striped end face. The upper and lower end faces of the rear side of the decorative board main body 1 are respectively formed with an insertion block 10 and an insertion block 11. Locking grooves 12, 13 are disposed on the insertion blocks 10, 11. An edge sealing plate 20 and an edge sealing plate 30 are disposed on the front edges of the left-side cover board 2 and the right-side cover board 3 and perpendicularly extend from the front edges for sealing the connection edges of the decorative board main body 1 and the left-side cover board 2 and the right-side cover board 3. The inner end faces of the left-side cover board 2 and the right-side cover board 3 are formed with breakage slits 21, whereby the left-side cover board 2 and the right-side cover board 3 can be broken along the breakage slits 21 to adjust the length in accordance with the size of the blind accessories. In addition, insertion frames 22 are disposed on the inner end faces of the left-side cover board 2 and the right-side cover board 3 for correspondingly inserting with the insertion blocks 10, 11 of the decorative board main body 1. The insertion frames 22 have more than one insertion spaces 23, 24. In addition, fastening stripes 25 and a slot 250 for a fastening screw to pass through are disposed in the insertion space 23. The fastening screw 26 is used to lock the decorative board main body 1 (as shown in FIG. 2), whereby the decorative board main body 1 and the left-side cover board 2 and the right-side cover board 3 are assembled with each other to form the structure of the decorative board substrate body (as shown in FIG. 2).

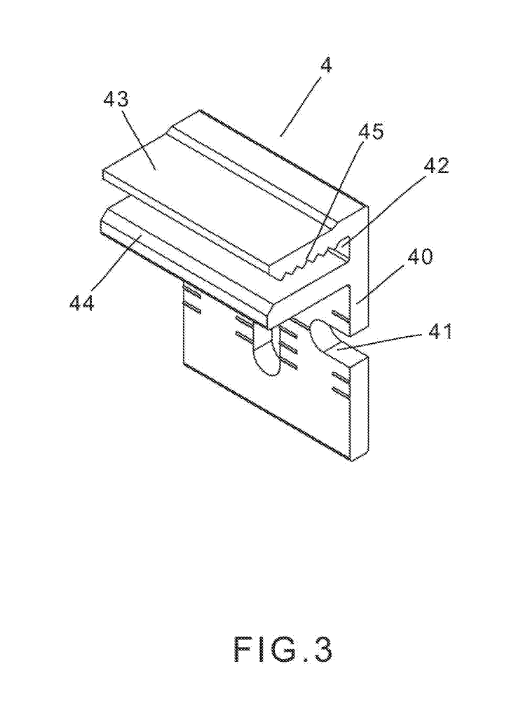

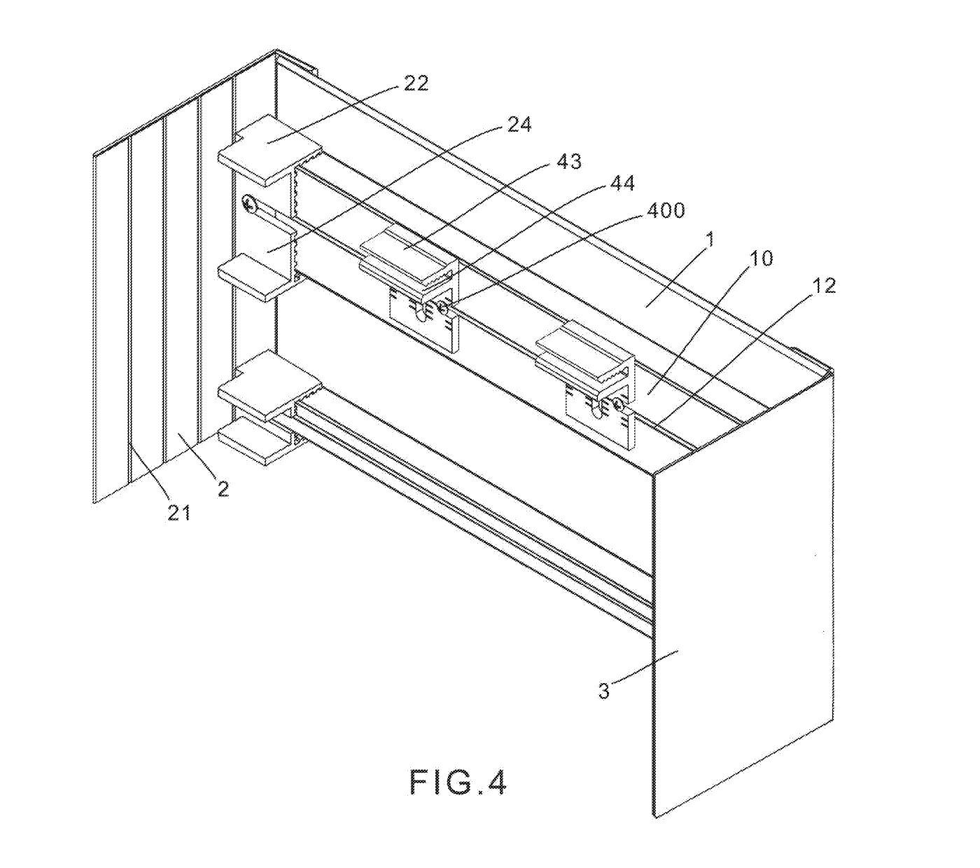

Moreover, referring to FIG. 3, the connection seat 4 includes a vertical plate 40, an adjustment notch 41 formed on the vertical plate 40 and a horizontal engagement channel 42 protruding from the upper side of the vertical plate 40. The horizontal engagement groove 42 is an insertion space defined between an upper plate body 43 and a lower plate body 44. Several engagement teeth 45 are formed on the inner face of the upper plate body 43. A fastening screw 400 is passed through the vertical plate 40 to securely connect the connection seat 4 on the upper insertion block 10 of the decorative board main body 1. The horizontal engagement groove 42 is for the hanging bracket 5 to connect therewith (as shown in FIG. 4).

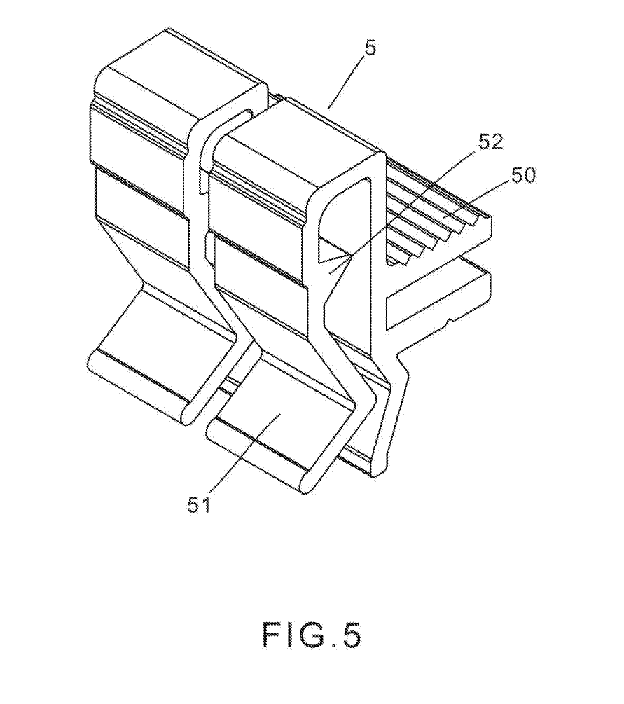

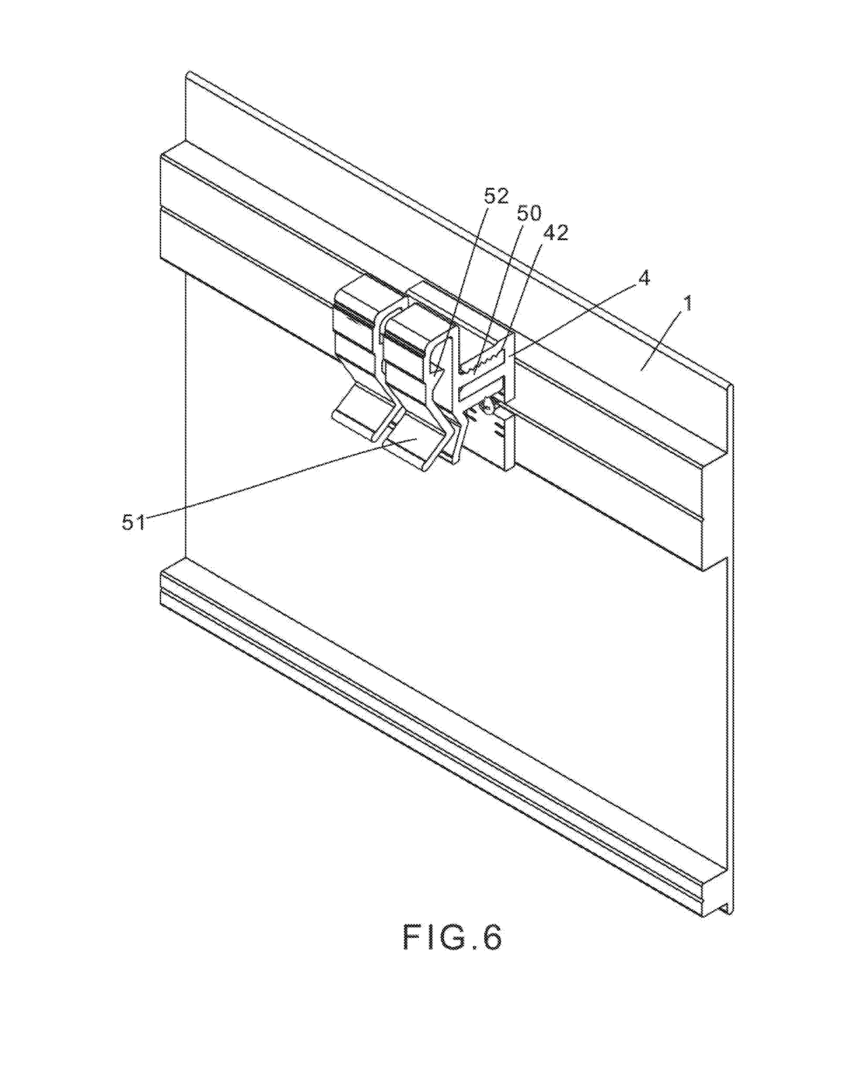

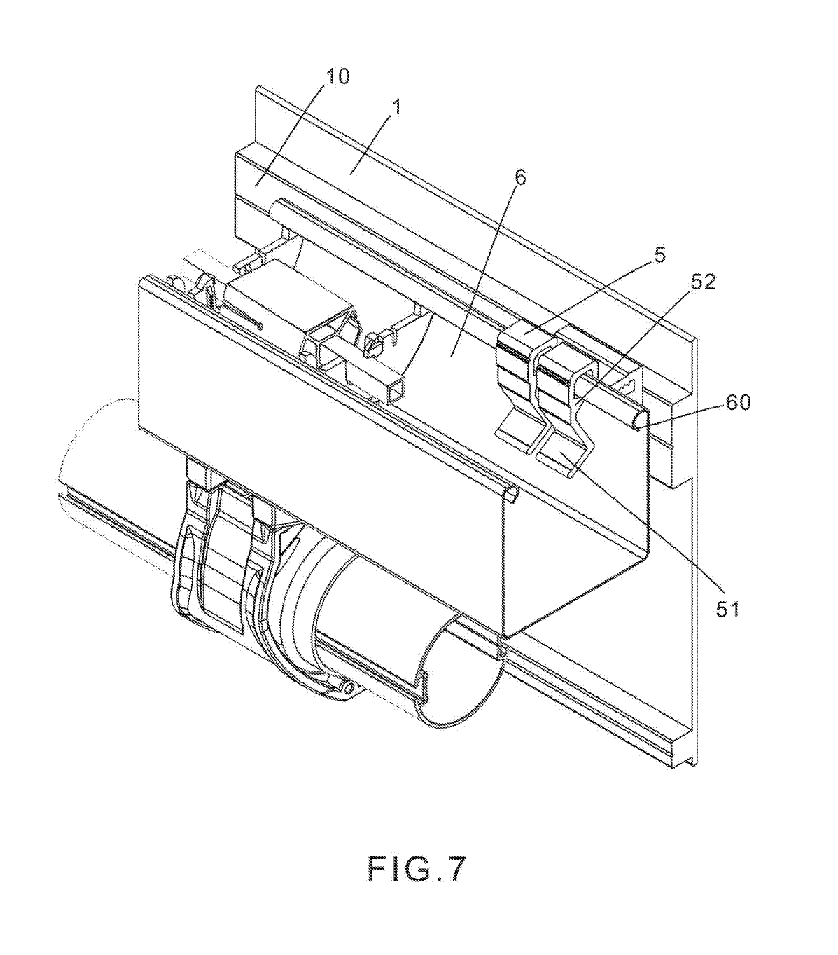

Referring to FIGS. 5 and 6, the hanging bracket 5 includes a toothed plate 50 for engaging with the horizontal engagement groove 42 of the connection seat 4 and a clip body 51 for hanging on and latching with the blind frame rail. A stop block 52 protrudes from the inner face of the clip body 51 for abutting against the inner side 60 of the blind frame rail 6 (as shown in FIG. 7).

Please refer to FIG. 1. When assembled, the upper and lower insertion blocks 10, 11 of the decorative board main body 1 are directly inserted into the insertion spaces 23 of the insertion frames 22 of the left-side cover board 2 and the right-side cover board 3. Under the fastening of the fastening stripes 26, the decorative board main body 1 can be more tightly assembled with the left-side cover board 2 and the right-side cover board 3. Then, the fastening screw 26 is used to lock the decorative board main body 1 to form the structure of the decorative board substrate body (as shown in FIG. 2). Thereafter, the connection seat 4 is securely disposed on the insertion block 10 of the decorative board main body 1 by means of the fastening screw 400 to connect with the decorative board substrate body. Then, the hanging bracket 5 is connected with the horizontal engagement groove 42 of the connection seat 4. The clip body 51 of the hanging bracket 5 is directly hanged on and latched with the blind frame rail 6, whereby the decorative board can cover the entire blind accessories to achieve a beautiful appearance (as shown in FIGS. 6 and 7).

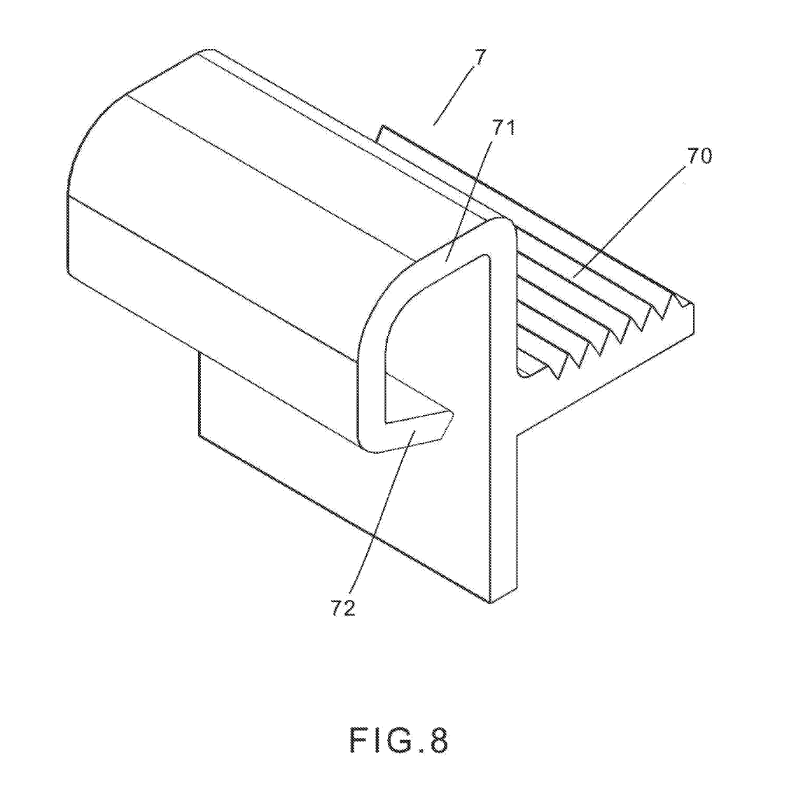

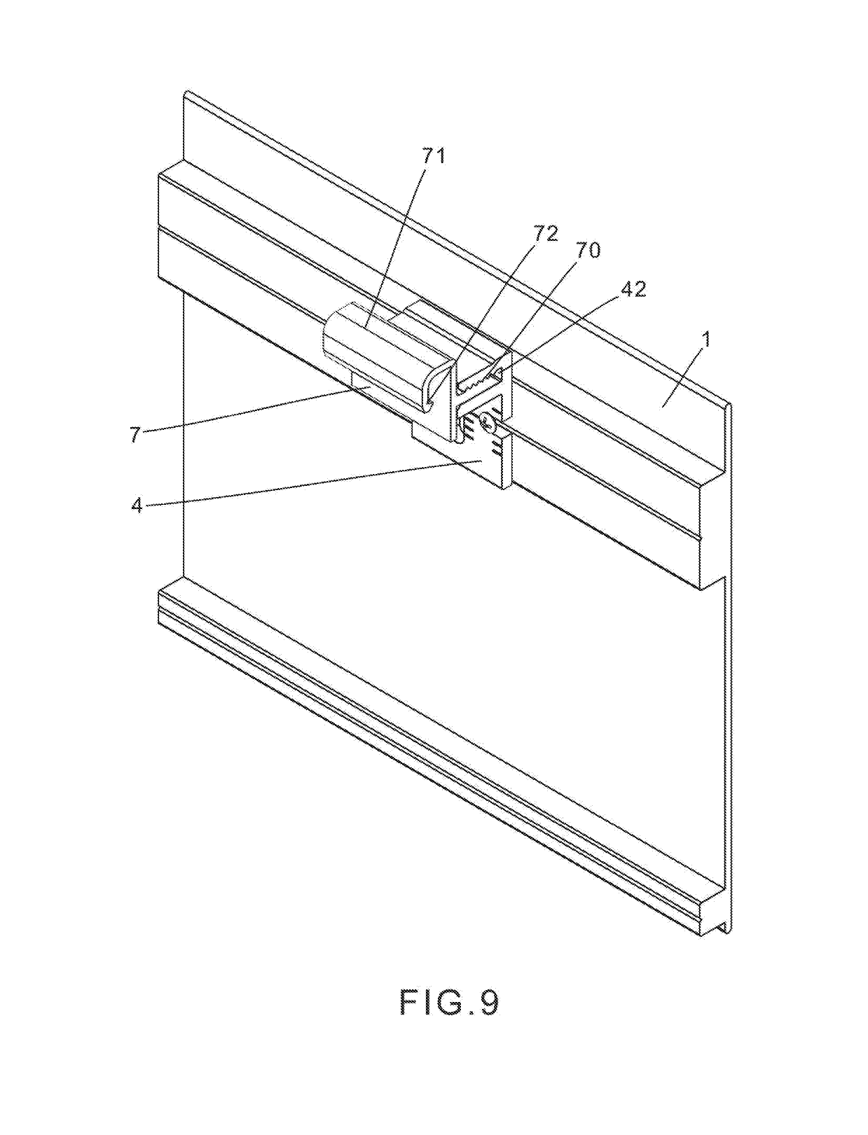

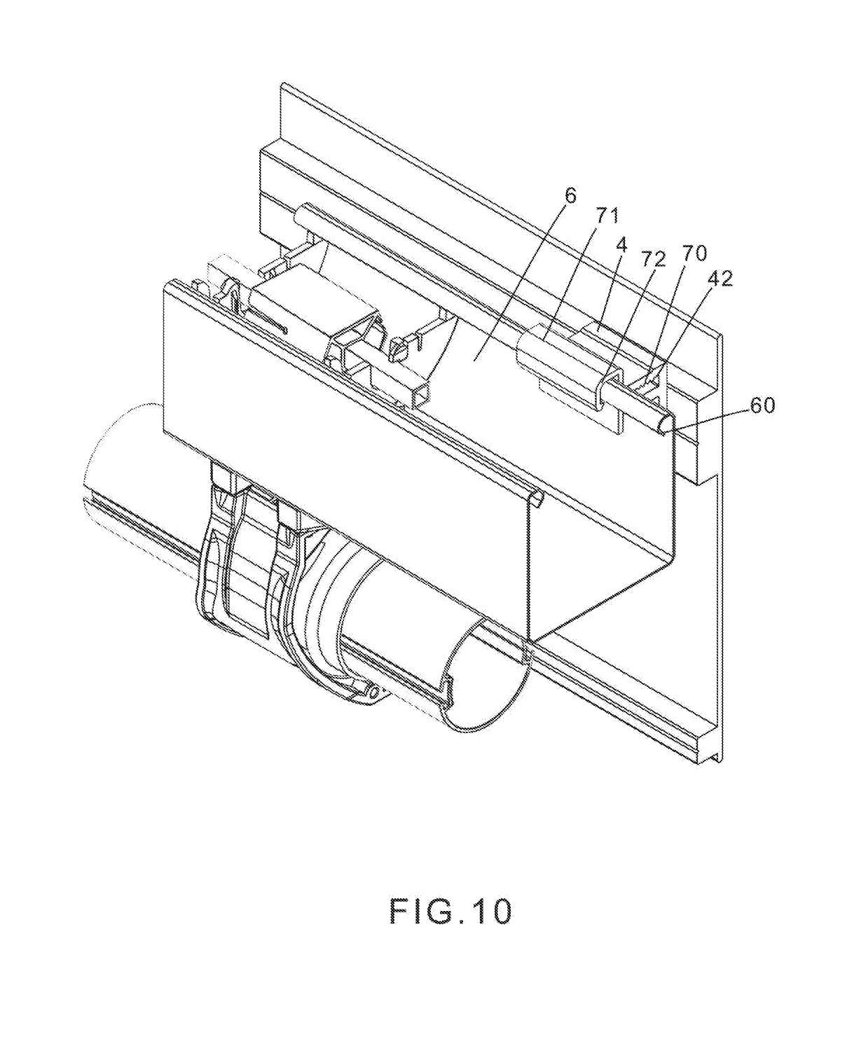

Please now refer to FIG. 8, which shows another embodiment of the hanging bracket of the present invention. The hanging bracket 7 includes a toothed plate 70 for engaging with the horizontal engagement groove 42 of the connection seat 4 and a clip body 71 for hanging on and latching with the blind frame rail 6. A stop block 72 protrudes from the tail end of the clip body 71 for abutting against the inner side 60 of the blind frame rail 6 (as shown in FIGS. 9 and 10).

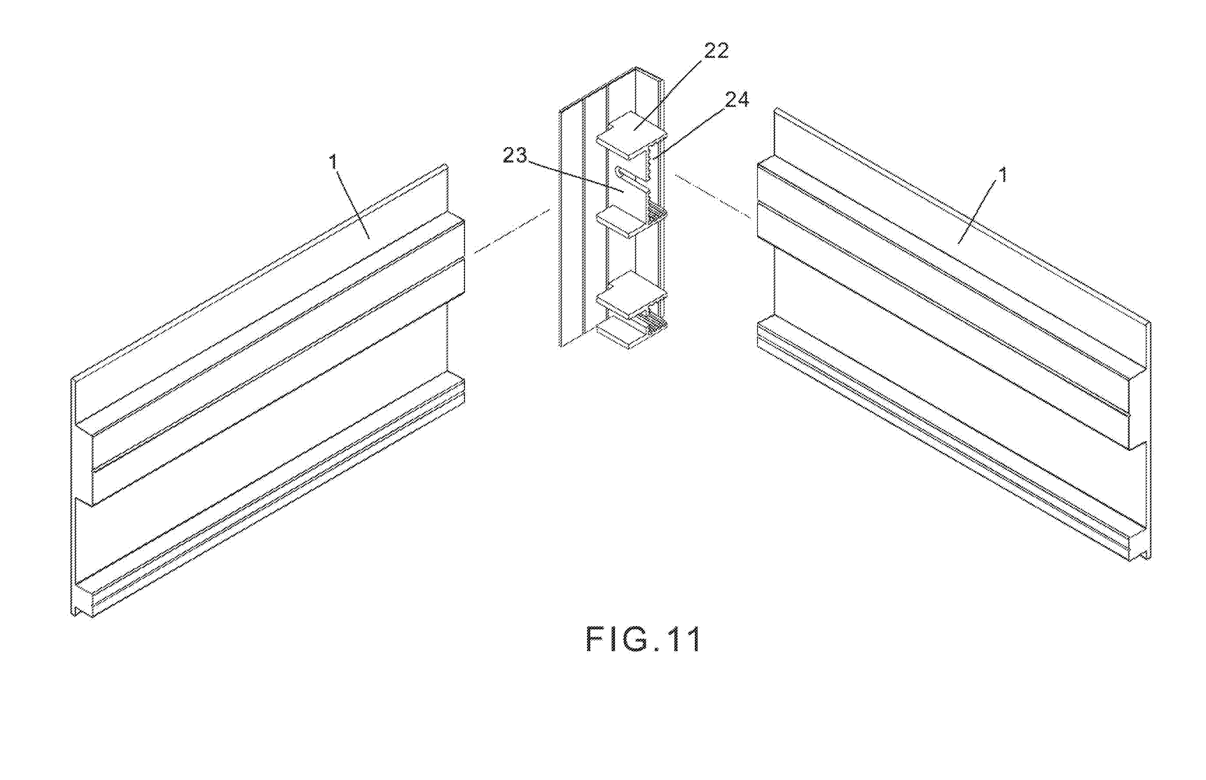

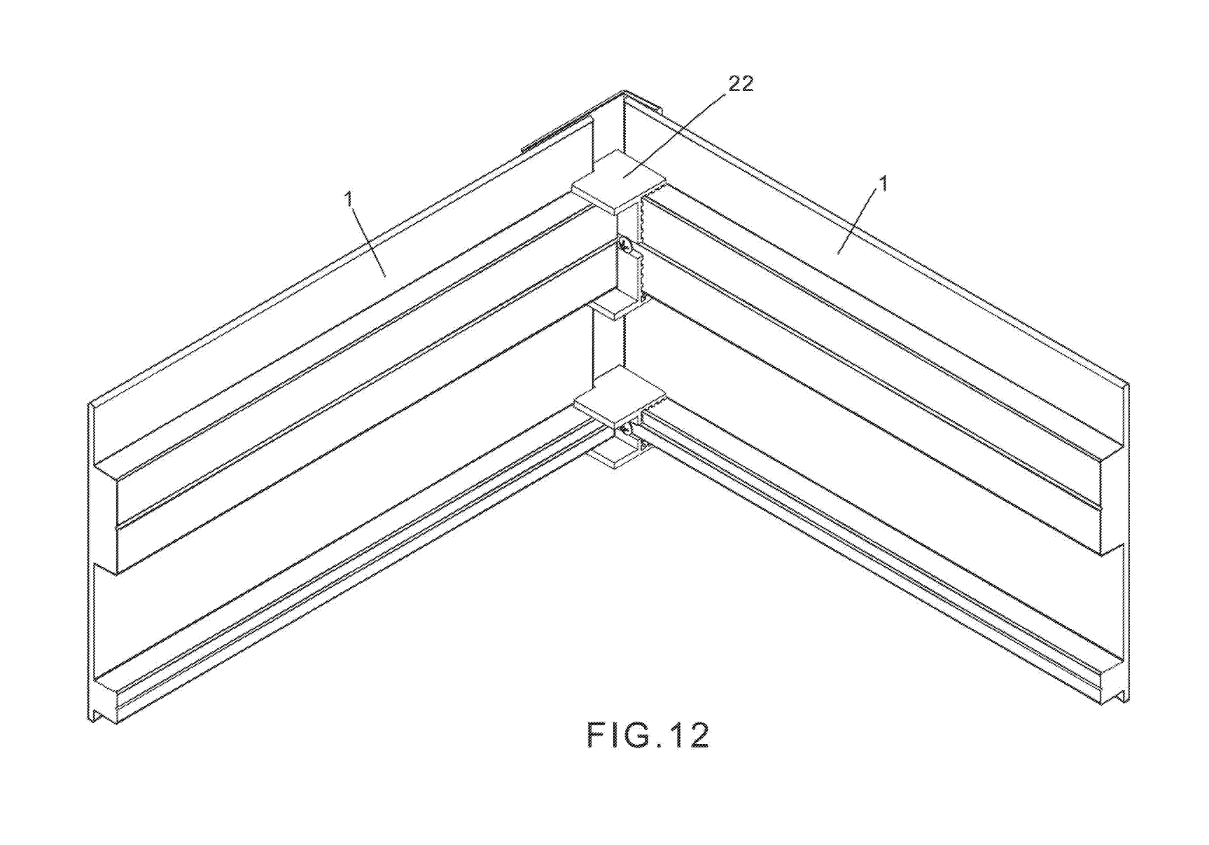

Please further refer to FIGS. 11 and 12, which show another embodiment of the decorative board main body assembly of the present invention. Two decorative board main bodies 1 are respectively inserted with the two insertion spaces 23, 24 of the insertion frames 22 of the left-side cover board 2 and the right-side cover board 3. Accordingly, the decorative board main bodies 1 can conceal two blind assemblies to achieve a beautiful appearance.

The above embodiments are only used to illustrate the present invention, not intended to limit the scope thereof. Many modifications of the above embodiments can be made without departing from the spirit of the present invention.

What is claimed is:

1. A blind decorative board fixing support assembly comprising:
a decorative board main body having a front end face formed with a plain panel, each of an upper end face and a lower end face of a rear side of the decorative board main body being formed with an insertion block;
a left-side cover board and a right-side cover board, inner end faces of the left-side cover board and the right-side cover board being formed with breakage slits and insertion frames for correspondingly inserting with the insertion blocks of the decorative board main body, each insertion frame having more than one insertion spaces for receiving and connecting with the insertion blocks of the decorative board main body;
more than one connection seats securely disposed on the insertion blocks of the decorative board main body, each connection seat including a vertical plate, an adjustment notch formed on the vertical plate and a horizontal engagement channel protruding from an upper side of the vertical plate, engagement teeth being formed on an inner face of the horizontal engagement channel for a hanging bracket to integrally engage and assemble; and
more than one hanging brackets, each hanging bracket including a toothed plate for engaging with the horizontal engagement groove of the connection seat and a clip body for hanging on and latching with a blind frame rail and clipping an inner side of the blind frame rail, whereby the decorative board main body and the left-side cover board and the right-side cover board are inserted and assembled with each other to form a decorative board substrate body structure, via the connection seats, the decorative board substrate body structure being respectively connected with the decorative board and the hanging brackets to hang on and latch with the blind frame rail so as to seal and cover the blind accessories and achieve a beautiful appearance and fast installation effect.

2. The blind decorative board fixing support assembly as claimed in claim 1, wherein an edge sealing plate is disposed on the front edge of each of the left-side cover board and the right-side cover board and perpendicularly extend from the front edge.

3. The blind decorative board fixing support assembly as claimed in claim 1, wherein locking grooves are further disposed on the insertion blocks of the decorative board main body.

4. The blind decorative board fixing support assembly as claimed in claim 1, wherein fastening stripes are further disposed in the insertion frames of the left-side cover board and the right-side cover board.

5. The blind decorative board fixing support assembly as claimed in claim 1, wherein the connection seat further has a slot for adjusting the height and position of the connection seat.

6. The blind decorative board fixing support assembly as claimed in claim 1, wherein a stop block is further disposed on an inner face of the clip body of the hanging bracket.
